(19) United States
(12) Patent Application Publication
(10) Pub. No.: US 2011/0023323 A1
(43) Pub. Date: Feb. 3, 2011

(54) DRYING SYSTEM FOR WEBS OF GOODS PASSING THROUGH IN THE FORM OF PRINTED AND/OR COATED PAPER WEBS

(75) Inventors: Rainer Härle, Schwieberdingen (DE); Stephan Krauss, Schwabach (DE)

Correspondence Address: LERNER GREENBERG STEMER LLP, P O BOX 2480, HOLLYWOOD, FL, 33022-2480, US

(73) Assignee: PRINOTEC GMBH, NÜRNBERG (DE)

(21) Appl. No.: 12/936,941

(22) PCT Filed: Jan. 28, 2009
(86) PCT No.: PCT/DE09/00113

§ 371 Date: Oct. 8, 2010

(30) Foreign Application Priority Data
Jun. 23, 2008 (DE) 10 2008 029 432.2

(51) Int. Cl. F26B 13/04

(52) U.S. Cl. 34/620

(57) ABSTRACT

A drying system contains a dryer unit for a web of goods passing through and eliminates solvents during the drying. The dryer unit has nozzles, which apply a drying gas to both paper web sides. The paper web passes through a first dryer region of the dryer unit and there drying gas is applied onto a first paper web site. A deflection roller is disposed between the first dryer region and a second dryer region. The deflection roller deflects the paper web to a second dryer region, where drying gas nozzles are directed at the second paper web side. Support gas nozzles that are directed at the second paper web side are provided at least in the first dryer region. A support gas is conducted through the nozzle at the second paper web side and has a lower pressure than the drying gas applied to the first paper web side.

The invention/innovation relates to a drying system for paper webs passing through in the form of printed and/or coated paper webs which, during drying, liberate solvents that become volatile, the dryer unit being equipped with nozzles in its interior, which apply a drying gas to both sides of the paper web passing through.

DE 26 16 347 describes a method and apparatus for heating a dryer and for the thermal re-combustion of the waste air from the dryer. In this case, use is made of what is known as a float dryer, which leads the material web to be led through the latter “floating” and supports it in a freely floating manner by means of float nozzles.

The invention/innovation is based on the object of developing a dryer system having the features of the preamble of claim 1 in such a way that the dryer system has a shorter length and can be produced more cost-effectively. Furthermore, it is an object of the invention to develop the drying system in such a way that the latter, incorporated into a drying gas recovery device, overall has a higher energetic efficiency and a better total energy balance.

This object is achieved by the characterizing features of claim 1. Advantageous developments of the invention emerge from subclaims 2-15.

It is viewed as the core of the invention that the dryer has two dryer regions, the paper web passing through a first dryer region and there having drying gas applied at least to a first paper web side. The paper web is deflected by a deflection roller within the dryer into a second dryer region. Therefore, the deflection roller forms the separation region between the first and the second dryer region. At least in the region of the deflection roller and/or the second dryer region, drying gas is applied to the second paper web side. At least before entering the second dryer region, the second paper web side has a supporting gas applied to it which has a lower pressure and/or volume flow than the drying gas acting on the first paper web side. In principle, a distinction is drawn between the gas acting as drying gas and the gas used as supporting gas; here, this can be the same type of gas which then differs only in the manner (alignment) and/or intensity of the application of the gas to the paper web. The application pressure of the supporting gas to the paper web side is lower than that of the drying gas.

The basic concept of the drying system provides for a first paper web side to be dried more intensely in a first dryer region, so that said side can be supported as early as possible on a deflection roller without, for example, printing ink on the paper web becoming smeared in the process. In order to configure the distance as far as the deflection roller to be as short as possible, it is advantageous to act on the paper web side that is acted on by the deflection roller with the highest possible pressure of the drying gas in the first dryer region. Tearing of the paper web is prevented by the second paper web side, opposite the first paper web side acted on by the deflection roller, being acted on by a supporting gas, which primarily has the function of supporting the paper web counter to the intensified drying gas pressure which acts on the first paper web side. Of course, a certain drying function also originates from the supporting gas. As a result of shortening the drying section as far as a first “supporting” deflection roller, the overall length of the dryer can be reduced.

In an advantageous embodiment, the first paper web side forms the top side of the paper web entering the dryer, and the second paper web side forms the opposite underside.

In a second, likewise advantageous embodiment, the first paper web side is oriented downward, at least in the first dryer region, and the nozzles applying the drying gas in the first drying region are arranged between the paper web and the ground. The fact that the drying nozzles act on the paper web from below with the drying gas, counter to the force of gravity which acts on the mass of the paper web, means that the force of gravity “pulling” the paper web downward acts as an opposing force oriented counter to the drying gas. As a result, the pressure of the drying gas can be increased further and, respectively, the nozzles of the supporting gas, which are arranged on the top side in this case and are oriented downward, act on and support the second paper web side with reduced pressure.

It is a further advantageous measure to arrange a second deflection roller on the second side of the paper web in the second dryer region and therefore to deflect the paper web once more. By means of the second deflection roller, which is preferably located on the same paper web side as the first deflection roller, the paper web can be supported very efficiently in the second dryer region at two bearing points. The consequence of this is that the second drying gas acting on the paper web side can impinge on the paper web with high pressure. In this connection, it is advantageous if the distance from the first to the second deflection roller is shorter than the distance of the application of drying gas to the first paper web side in the first dryer region. Since the paper web in the first dryer region is supported only on one side within the dryer on the first deflection roller, the pressure of the drying gas for the first paper web side cannot be chosen to be arbitrarily high. If a minimum structural volume is to be achieved for the dryer device, the distance between the first and the second deflection roller can be minimized since, as a result of the support on the first and second deflection roller, the drying gas for the second paper web side can be chosen to be higher than the drying gas application pressure for the first paper web side within the first dryer region.

A particularly advantageous arrangement of the drying nozzles applying the drying gas is seen in aligning the nozzles applying the drying gas at an acute (shallow) angle with respect to the paper web and therefore arranging for the applied drying air to impinge on the paper web at a corresponding angle. Such an oblique position of the drying nozzles achieves the situation where the force acting perpendicular to the web from the drying gas acting on the paper web is reduced further, so that the supporting gas provided on the opposite paper web side, at least in the first drying region, only has to support part of the force of the drying gas application. It is therefore made possible to reduce the necessary input of energy for the supporting gas. Furthermore, it is advantageous to arrange the supporting gas nozzles blowing out the supporting gas in such a way that the supporting gas is led substantially perpendicularly against the paper web side facing them. In this way, the energy consumption of the supporting gas nozzles is designed with a higher effect for the support of the paper web.

Preferably, during or after the first deflection roller, at least the second paper web side is acted on in the manner of an impingement jet drying system.

According to an advantageous refinement of the apparatus, the supply of the drying gas and/or supporting gas within the dryer is variable in terms of air quantity and/or temperature. Variability of this type in relation to the paper web can be achieved by varying the drying gas pressure, the drying gas volume flow, the alignment of the nozzles and/or by means of heating or cooling means for changing the temperature of the gas. Such variability is advantageous in particular in order to optimize the process sequence within the drying system as a function of different paper web thicknesses and/or materials.

In order to avoid the uncontrolled escape of the solvent evaporating from the paper web out of the dryer, it is advantageous if the latter has a sealing air zone in each case in its inlet and outlet region. In this case, the temperature and/or quantity of the sealing air in the sealing air zone can be adjusted variably, in a manner comparable with the above described supply of the drying gas, so that the consumption of sealing air can be adjusted as a function of the quantity of the diffusing solvent and/or the passage speed of the paper web.

The exhaust air led away from the drying system is full of solvents and, following the drying system, can be supplied to an oil recovery unit connected downstream, so that the waste air is freed of component parts of the solvent and the exhaust air emerging from the oil recovery unit can, at least to some extent, be used as sealing air for the drying system. The fact that the exhaust air from the oil recovery unit has a temperature of 20° C. to 50° C. means that this can preferably be used for the sealing air of the drying system, since it does not represent any source of cold within the drying system, endangering the action of the latter.

In the development of the invention, a gas turbine is connected upstream of the drying system, and the exhaust gas emerging from the gas turbine is used, at least to some extent, as a drying gas within the drying system. The exhaust gas emerging from the gas turbine has a relatively high temperature and, since the CO₂ content of the exhaust gas from the gas turbine does not hinder the drying process of the paper web, the exhaust gas from the gas turbine is a suitable medium for drying the paper web. In particular when the exhaust gas from a gas turbine is used as drying gas, it is advantageous if the drying system has at least two dryers running in parallel, in which in each case a paper web passing through is dried. As a result of the parallel connection of different dryers, which may possibly have different performance capacities, one of the two dryers or a plurality of dryers can be operated simultaneously, depending on the demand for dryer performance. Since a gas turbine can in principle be operated economically only in a very narrow range, it is possible to compensate for production fluctuations in the print shop by means of the parallel connection of a plurality of drying systems.

In addition to a gas turbine, other internal combustion engines can also be used as a drying gas or exhaust gas source.

The invention is explained in more detail by using exemplary embodiments in the drawing figures, in which:

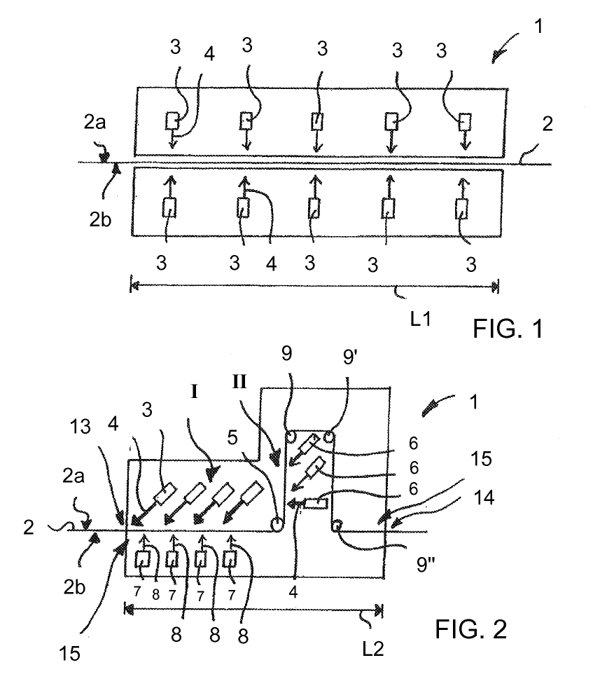

FIG. 1 shows a schematic illustration of an integrated dryer according to the prior art;

FIG. 2 shows a schematic illustration of a dryer according to the invention;

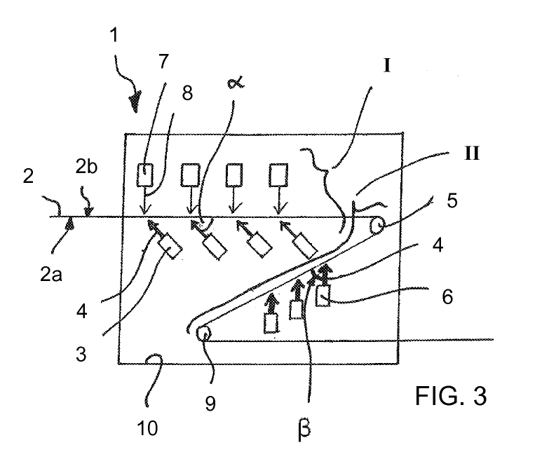

FIG. 3 shows a schematic illustration of an alternative dryer according to the invention;

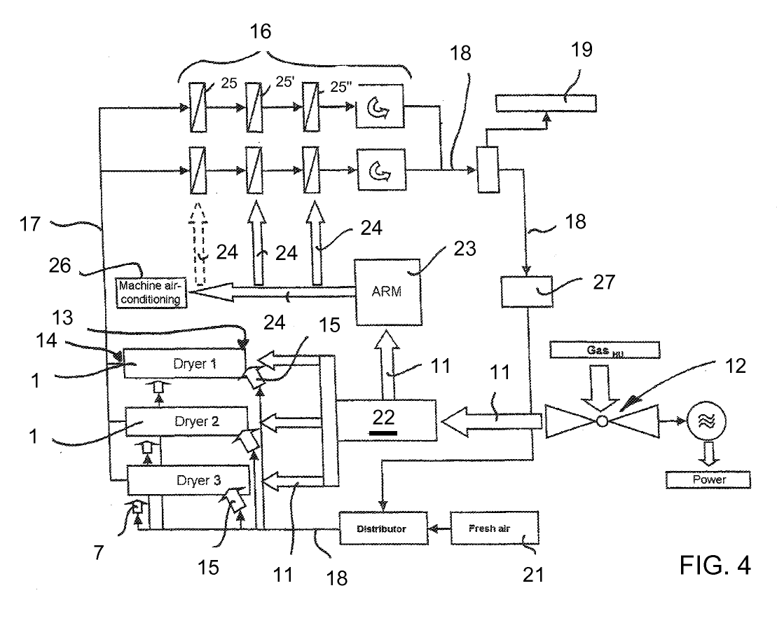

FIG. 4 shows a schematic illustration of the integration of the dryer according to the invention into a dryer exhaust air treatment circuit of a print shop;

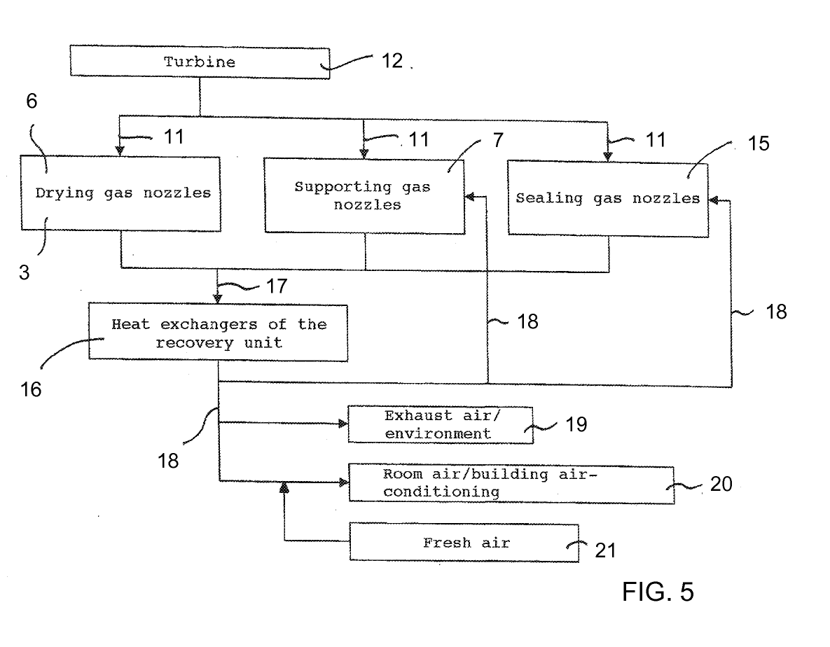

FIG. 5 shows an illustration of the sequence reduced to the stations of the gas used for drying in the dryer.

A dryer unit 1 corresponding to the prior art, through which a web of goods passes in the form of a printed and/or coated paper web 2, is depicted in drawing FIG. 1. This paper web 2 originates from a printing process so that, during the drying of the paper web 2, the solvents contained in the printing inks become volatile and accumulate in the dryer air. The dryer unit 1 is equipped in its interior with nozzles 3, which apply a drying gas 4 to both paper web sides 2A, 2B of the paper web 2 passing through. The fact that the paper web 2 is in this case borne in a floating manner by the drying gas 4 from the nozzles 3 within the dryer unit 1 means that only a limited gas pressure/gas volume can be set, so that the overall apparatus has a length L₁ necessitated by the structure for reliable drying.

In the dryer unit 1 illustrated in drawing FIG. 2, the paper web 2 passes through a first dryer region I and there is acted on by a drying gas 4, at least on a first paper web side 2A. The paper web 2 is subsequently deflected on a deflection roller 5 arranged between the first dryer region I and a second dryer region II within the dryer unit 1 into the second dryer region II. The first and the second dryer region I, II are defined as the regions I, II for drying the paper web 2 arranged before and after the first deflection roller 5. At least in the region of the deflection roller 5 and/or the second dryer region II, drying nozzles 6 directed toward the second paper web side 2 are arranged and are aligned in such a way that the drying gas 4 applied from the latter acts on the second paper web side 2B. In the first dryer region I there are arranged what are known as supporting gas nozzles 7, which lead the supporting gas 8 applied from them against the second paper web side 2B, the supporting gas 8 having a lower pressure and/or a lower volume flow than the drying gas 4 acting on the first paper web side 2A.

As a result of the arrangement of the deflection roller 5 and possibly further deflection rollers 9, 9′, 9″ while taking into account the arrangement of the drying nozzles 3, 6 and supporting gas nozzles 7, the paper web 2 can be displaced and dried within the dryer in such a way that the technically necessitated length of the dryer unit 1 can be reduced to a length L₂. The length of the dryer unit according to the invention, L₂, is at least 10% (up to 45%) less than the length L₁ of the dryer units 1 used in the prior art and supporting the paper web 2 in a floating manner.

In the embodiment of the dryer unit 1 illustrated according to FIG. 2, the first paper web side 2A is directed upward (top side of the paper web 2 entering the dryer 1), and the second paper web side 2B is the opposite underside.

In drawing FIG. 3, this principle is turned round, so that the first paper web side 2A points downward, at least in the first dryer region I, and the nozzles 3 applying the drying gas 4 in the first dryer region 1 are arranged between the paper web 2 and a dryer region I located underneath (dryer underside 10). In this case, the dryer underside 10 is the installation surface with which the dryer unit 1 is oriented toward the floor. Since the drying gas 4 impinges on the paper web side 2A from below (counter to the force of gravity), the inherent weight of the paper web 2 acts as a first opposing force counter to the force of application of the drying gas 4 from the drying nozzles 3. The intensity of the arrows symbolizing the drying gas 4 and the supporting gas 8 is intended to provide information about the pressure and/or the extent of the volume flow of the drying gas 4 and the supporting gas 8, respectively. In particular in the first, downwardly oriented paper web side 2A, which is acted on first with drying gas 4, the quantity of supporting gas 8 can be reduced as compared with the embodiment according to FIG. 2 by means of a reduction in the supporting gas 8 (because of the utilization of the inherent weight of the paper web 2).

In the embodiment according to the invention according to FIG. 2 or 3, the paper web 2 is acted on with supporting gas 8 on the second paper web side 2B in the first dryer region I, it being possible for the supporting gas 8 also to have a drying function and therefore to be designated as drying gas having a lower pressure and/or volume flow than the drying gas 4 acting on the first paper web side 2A in the first region I of the dryer unit 1.

The dryer unit 1 is preferably provided in the second dryer region II with a second deflection roller 9, which is arranged on the second side 2B of the paper web 2 and deflects the paper web 2 therewith once more.

The fact that in the first dryer region I the first paper web side 2A is acted on with a drying gas 4 and, at the same time, the second paper web side 2B is acted on with a supporting gas 8 and the deflection roller 5 supports the paper web 2, means that the pressure and/or volume flow of the drying gas can be increased sharply with respect to the prior art. Furthermore, the second paper web side 2B is already pre-dried by the application of supporting gas. As a result of this pre-drying of the second paper web side 2B, its actual drying phase (dryer region II) can be kept relatively short. The situation is therefore reached in which the distance of the application of drying gas to the first paper web side 2A is longer than the drying gas application distance of the second paper web 2B during the first deflection roller 5 and/or after the first deflection roller 5 (second dryer region II). Alternatively, this fact can also be presented in such a way that the distance between the first and the second deflection roller 5, 9 is shorter than the distance of the application of drying gas to the first paper web side 2A in the first dryer region I.

As illustrated, the drying nozzles 3, 6 applying the drying gas can be arranged in such a way that the applied drying gas 4 impinges on the paper web 2 at a shallow angle α, β. The drying nozzles 3, 6 applying the drying gas 4 and arranged at a shallow angle α, β relative to the paper web 2 can be arranged in the first dryer region I (acting on the paper web side 2A) and/or in the second dryer region II (acting on the second paper web side 2B). As a result of the oblique position of the drying nozzles 3, 6, the application pressure and/or the volume flow of the drying gas 4 can be increased without any risk of damaging the paper web 2 being provided thereby. The supporting gas nozzles 7 blowing out the supporting gas 8 are arranged substantially in such a way (preferably perpendicularly) that they lead the supporting gas perpendicularly toward the paper web side 2A, 2B facing them.

During and/or after the first deflection roller 5, at least the second paper web side 2B can be acted on with drying gas 4 in the manner of an impingement jet drying system.

In drawing FIG. 4, the dryer unit 1 is employed within a print shop system; in this case, the drying gas 4 used is, at least to some extent, the exhaust gases 11 from an internal combustion engine 12 connected upstream of the drying system or the dryer unit 1. An internal combustion engine 12 can be constructed, as illustrated, as a fluidic machine (gas turbine) but also internal combustion motors, such as reciprocating piston motors, rotary piston motors or dual-rotary piston motors can in principle be used. The exhaust gas 11 from the internal combustion engine 12 has a high temperature (e.g. 400-520° C.) necessitated by the combustion process, which, in this case, can be used for drying the paper web 2 in the dryer unit 1. Since such an internal combustion engine 12 can be regulated only under certain circumstances, at least in the case of a gas turbine, it is advantageous if the drying system comprises a plurality of parallel-connected dryer units 1. Furthermore, it is advantageous if the supply of the drying gas 4 within the dryer unit 1 is variable in terms of air quantity and/or temperature. Therefore, depending on the use of specific solvents and/or different paper grades, the drying unit 1 can be adjusted in a process-optimized manner. In the inlet and outlet regions 13, 14 of the paper web 2 of the dryer unit 1, in each case there is arranged a sealing gas zone 15 having at least one sealing gas nozzle (not illustrated). By means of the sealing gas zones 15, for example, emergence of the exhaust gases 11 used as drying gas 4 from the dryer unit 1 can be prevented; in particular the CO₂ content of the exhaust gases 11 requires measures to prevent an uncontrolled excessive emergence of the exhaust gases 11 from the dryer units 1. In addition, the sealing gas in the sealing gas zones 15 can be adjusted variably in terms of quantity and/or temperature.

Connected downstream of the dryer unit 1 is at least one oil recovery unit 16, in which the gas 17 loaded with solvents is led from the dryer unit 1 to the oil recovery unit 16. The exhaust gas 18 emerging from the oil recovery unit 16 is, at least to some extent, supplied to the sealing gas nozzles of the sealing gas zones 15 in the inlet and/or outlet region 13, 14 of the dryer unit 1. As a result of the reuse of the original drying gas 4 for use as a sealing gas, the net energy consumption and, in particular, the gas consumption of the dryer unit can be reduced. In drawing FIG. 4, the sealing gas zones 15 are illustrated symbolically by a somewhat obliquely placed arrow 15 belonging to the respective dryer unit 1. Furthermore, the exhaust gas 18 can alternatively or additionally be led to the supporting gas nozzles 7 (illustrated symbolically as a vertical arrow 7). Since the supporting gas 8 is intended to be used for drying only with secondary importance, the cooling of the exhaust gas 18 by the oil recovery unit 16 is not critical. The supporting function can be implemented reliably by the exhaust gas 18. The cooled exhaust gas 18 can also be used as a supporting gas 8 with the admixture of exhaust gas 11 from the internal combustion engine.

The feedback of circulated air relating to the gas 18 emerging from the oil recovery unit 16 can, for example, comprise further cooling of the gas 18 to 20° C. to 30° C. by means of a re-cooler 27. About 60% by volume of the gas 18 is preferably blown freely into an enclosure (not illustrated) surrounding the dryer unit 1 and about 40% by volume is used as sealing gas for the dryer unit 1.

Some of the exhaust gas 11 from the internal combustion engine 12 is supplied via a control and regulating unit 22 to an absorption refrigerating machine 23. The refrigeration energy (thermal energy) 24 produced in the absorption refrigerating machine 23 is used to some extent for cooling the heat exchangers 25, 25′, 25″ of the oil recovery unit 16 and/or for cooling other machines 26 specific to the print shop or for the air-conditioning of rooms.

In drawing FIG. 5, the possible uses of the gas within the overall system are illustrated schematically once more; here the exhaust gas 11 from the internal combustion engine 12 is supplied to the drying gas nozzles, supporting gas nozzles 7 and/or the sealing gas nozzles of the sealing gas zone 15. The gas 17 discharged from these respective nozzles 3, 6, 7, 15 is supplied to heat exchangers (25, 25′, 25″) of the oil recovery unit 16 and, after passing through the latter, is employed for the use as supporting gas 8, as sealing gas, as exhaust air 19 (into the environment) and/or, by means of the admixture of fresh air 21, as room air 20 or building air-conditioning. In particular as a result of coupling the exhaust gas 18 back to the supporting gases 7 or to the sealing gas nozzles of the sealing gas zone 15, despite intensive use of drying gas 4, supporting gas 7 and sealing gas, as compared with the prior art, an overall economic system is achieved.

When the exhaust gas 18 is used for the supporting gas nozzles 7 or for the sealing gas nozzles of the sealing gas zone, exhaust gas 11 from the internal combustion engine 12 can be admixed with the gas 18.

### LIST OF DESIGNATIONS

L₁ Length (prior art)
L₂ Length (invention)
I Dryer region
II Dryer region
1 Dryer unit
2 Paper web
2A, 2B Paper web side
3 Nozzles of I
4 Drying gas
5 Deflection roller
6 Drying nozzles of II
7 Supporting gas nozzles
8 Supporting gas
9, 9′, 9″ Further deflection rollers
10 Dryer underside
11 Exhaust gas from 12
12 Internal combustion engine
13 Inlet region
14 Outlet region
15 Sealing gas zone
16 Oil recovery unit
17 Gas from 1
18 Exhaust gas from 16
19 Environment
20 Room air
21 Fresh air
22 Control and regulating unit
23 Absorption refrigerating machine
24 Refrigeration energy
25, 25′, 25″ Heat exchangers
26 Machines
27 Re-cooler

1-15. (canceled)

16. A drying system, comprising:
at least one dryer unit for at least one web of goods passing through in a form of at least one of printed paper webs and coated paper webs which, during drying, liberate solvents that become volatile, said dryer unit having an interior with nozzles disposed in said interior, said nozzles applying a drying gas to both sides of a paper web passing through, said dryer unit having a first dryer region and a second dryer region, the paper web passing through said first dryer region of said dryer unit and there having the drying gas applied at least to a first paper web side of the paper web;
said dryer unit having a deflection roller disposed between said first dryer region and said second dryer region for deflecting the paper web within said dryer unit into said second dryer region;
said dryer unit having drying gas nozzles disposed at least in a region of at least one of said deflection roller and said second dryer region, said drying gas nozzles being directed toward a second paper web side of the paper web; and
said dryer unit having support gas nozzles disposed at least in said first dryer region, said supporting gas nozzles being directed toward the second paper web side, through which a supporting gas is led toward the second paper web side, the supporting gas having a lower pressure than the drying gas acting on the first paper web side.

17. The drying system according to claim 16, wherein the first paper web side is a top side of the paper web entering said dryer unit, and the second paper web side is an opposite underside.

18. The drying system according to claim 16, wherein the first paper web side points downward, at least in said first dryer region, and said nozzles applying the drying gas in said first dryer region are disposed between the paper web and a dryer region lying underneath.

19. The drying system according to claim 16, wherein the paper web in said first dryer region has the drying gas supplied to it on the second paper web side, the drying gas acting on the second paper web side in said first dryer region with at least one of a lower pressure and volume flow than the drying gas acting on the first paper web side in said first dryer region.

20. The drying system according to claim 16, wherein said drying unit has a second deflection roller disposed in said second drying region, said second deflection roller is disposed on the second paper web side of the paper web and deflects the paper web once more.

21. The drying system according to claim 20, wherein a distance between said first and second deflection rollers is shorter than a distance of an application of the drying gas to the first paper web side in said first dryer region.

22. The drying system according to claim 16, wherein said drying gas nozzles applying the drying gas are disposed such a way that the applied drying gas strikes the paper web at a shallow angle.

23. The drying system according to claim 16, wherein said support gas nozzles blowing out the supporting gas lead the supporting gas substantially perpendicularly toward the paper web side facing them.

24. The drying system according to claim 16, wherein at least one of during and after said first deflection roller, at least the second web side experiences impingement jet drying.

25. The drying system according to claim 16, wherein a supply of at least one of the drying gas and the supporting gas within said dryer unit is variable in terms of at least one of air quantity and air temperature.

26. The drying system according to claim 16, wherein said dryer unit includes an inlet region for the paper web and an outlet region for the paper web, each of said inlet region and said outlet region having a sealing gas zone each with at least one sealing gas nozzle.

27. The drying system according to claim 26, wherein a quantity of sealing gas in said sealing gas zone can be adjusted variably.

28. The drying system according to claim 16, further comprising an internal combustion engine, the drying gas is an exhaust gas from said internal combustion engine connected upstream of said drying unit.

29. The drying system according to claim 26, further comprising an oil recovery unit connected downstream of said drying unit, and an exhaust air from said oil recovery unit can, at least to some extent, be supplied to said sealing gas nozzle in at least one of said inlet region and said outlet region.

30. The drying system according to claim 16, wherein said drying unit is one of at least two dryers running in parallel, in which in each case the paper web passing through is dried.
